(19) United States
(12) Patent Application Publication
(10) Pub. No.: US 2013/0080284 A1
(43) Pub. Date: Mar. 28, 2013

(54) SYSTEMS AND METHODS OF OFFERING A COLLECTION FOR SALE

(71) Applicant: Margaret Helen Green, San Jose, CA (US)

(72) Inventor: Margaret Helen Green, San Jose, CA (US)

(73) Assignee: eBay Inc., San Jose, CA (US)

(21) Appl. No.: 13/247,456

(22) Filed: Sep. 28, 2011

(51) Int. Cl. G06Q 30/06; G06Q 30/08

(52) U.S. Cl. 705/26.4

(57) ABSTRACT

A system and method of offering a collection for sale is disclosed. A collection input module may receive a description of a collection and description of items in the collection from a device of a seller. A collection sale module may offer the collection for sale by publishing a description of a sale of the collection as a whole according to a first offering type. An item sale module may offer the items in the collection for sale by publishing descriptions of the respective items in the collection concurrently with the offer for sale of the collection as a whole according to a second offering type. A comparison module may, upon conclusion of an offering period, compare a sum of bids for the respective items to a bid for the collection as a whole and to determine whether the collection is sold as a whole based on the comparison.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011 by eBay, Inc. All Rights Reserved.

### TECHNICAL FIELD

This patent document pertains generally to network communications, and more particularly, but not by way of limitation, to systems and methods of offering a collection for sale.

### BACKGROUND

In a situation where a collector wishes to liquidate a collection of items, the collector has no way of knowing whether selling the items individually or as a single lot would fetch a higher price. The collection may include one or more items that are worth substantially more than other items in the collection that would fetch a large profit individually but would leave the collector with the remaining items in the collection. Further, for emotional reasons or simply to reduce transaction costs incurred by the collector, the collector may prefer to sell the collection as a whole rather than selling off individual items.

Current online auction systems and marketplaces allow a collector to list the collection as a whole or as separate listings for each item in the collection. As such, the collector is not able to make an educated decision regarding whether to sell the collection as a whole or as individual items.

### BRIEF DESCRIPTION OF DRAWINGS

Some embodiments are illustrated by way of example and not limitation in the figures of the accompanying drawings in which:

FIG. 1 is a diagrammatic representation of an example networked environment in which one or more embodiments may be practiced.

FIG. 2 is a block diagram illustrating an example collection system, as may be used in an example embodiment.

FIG. 3 is a flow chart illustrating a method to offer a collection for sale, according to an example embodiment.

FIG. 4 is a portion of an example user interface that may be displayed in an example embodiment.

FIG. 5 is a portion of another example user interface that may be displayed in an example embodiment.

FIG. 6 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Online marketplaces allow sellers (e.g., people and business entities) to publish listings describing items being offered for sale to potential buyers. The online marketplace may support one or more offering types, including, for example, fixed price sales, auctions, and hybrids thereof. The online marketplace may provide transaction services to the sellers such as payment services, shipping services, conflict resolution services, and the like.

When a seller wants to sell a collection of items on the online marketplace, the seller first decides whether to sell the collection as a whole, in parts (e.g., subsets of items in the collection), or as individual items. The seller, however, may not actually want to make the decision before learning more about the value of the respective items in the collection or the value of the collection as a whole.

In an embodiment, the seller is allowed to publish a listing describing the collection as whole while simultaneously publishing separate listings describing the respective individual items in the collection. The seller provides a description of each item in the collection and then provides listing settings. The listing settings are set independently for the collection and for the respective items in the collection. The seller may optionally set the listing settings to bias the listing towards selling the collection as a whole.

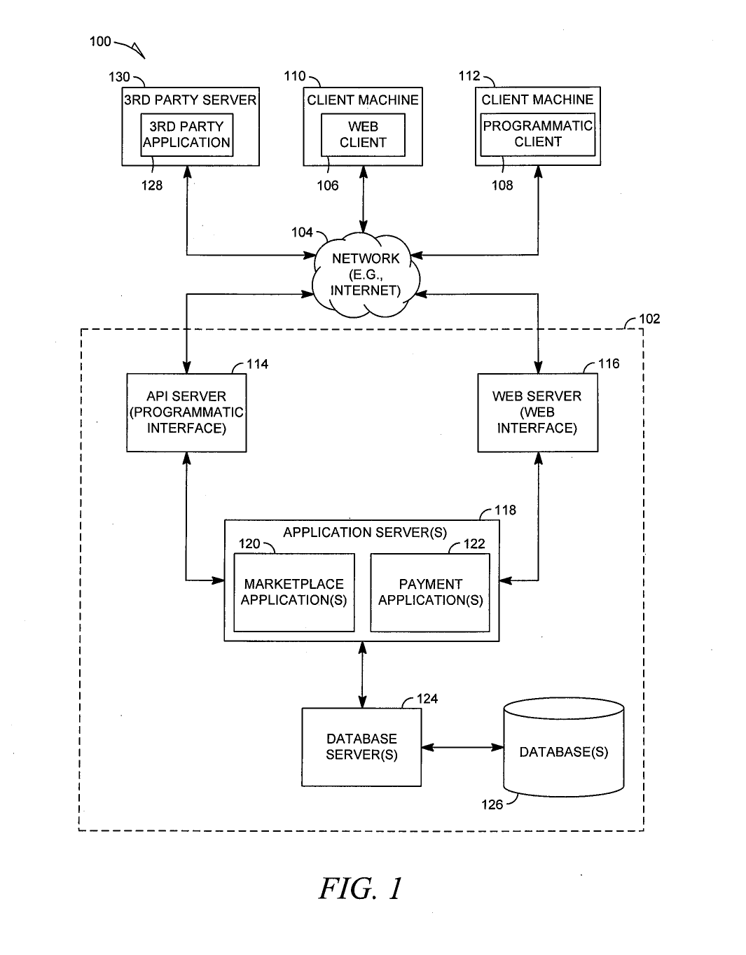

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

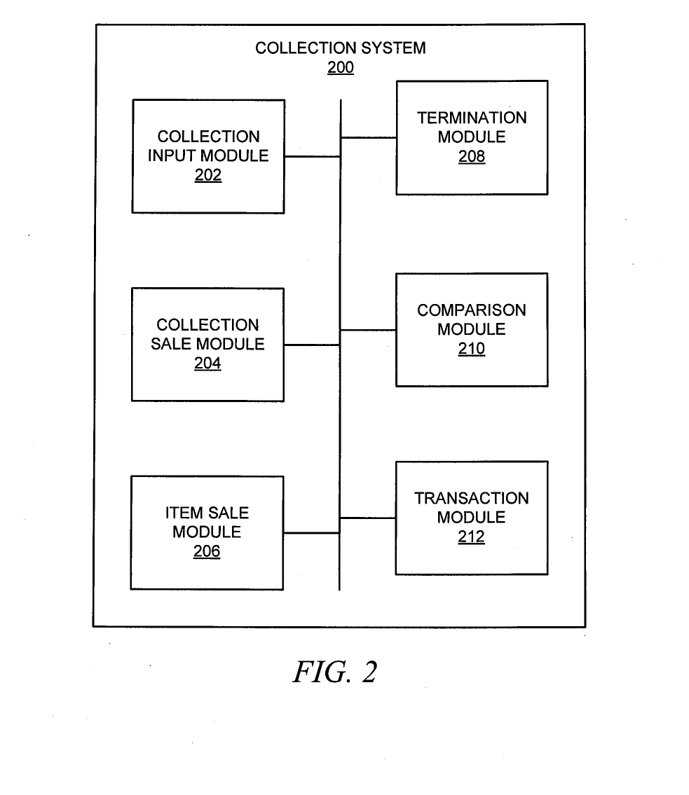

FIG. 2 is a block diagram illustrating an example collection system 200, as may be used in an example embodiment. The collection system 200 may be implemented in hardware, software, or a combination thereof. For example, the collection system 200 may be implemented as a plurality of hardware modules in electronic communication with one another. In another embodiment, the collection system 200 may be implemented as a number of software modules executed by one or more processors.

Within the collection system 200, a collection input module 202 is to receive information about the items in the collection from a client device of the seller. The information may include images, a text description, a video, a product code, a condition of the item, and the like received via a client device used by the seller. In some instances, a collection input module 202 may include one or more product recognition features that automatically identify an item based on an image of the item and/or a bar code identifying the item. In some instances, the product recognition features may identify one or more items depicted by a single image.

In some embodiments, the collection input module 202 may allow more than one seller to add items to a collection. For example, a first seller may have a collection of items that the first seller wishes to sell. The first seller may be acquainted with one or more additional sellers who have items to sell that compliment the collection of the first seller. The first seller may allow the additional sellers to electronically add their items to the collection for sale.

A collection sale module 204 sets the listing settings for selling the collection as a whole based on input received from the seller. The listing settings for selling the collection include, for example, the offering type of the collection sale. If the offering type is a fixed price sale, the listing settings include a fixed price for the collection. If the offering type is an auction, the listings settings include a reserve price and a duration of the auction. If the offering type is a hybrid, the listings settings may include a reserve price to be met if the collection is auctioned and a fixed price exceeding the reserve price that triggers an immediate sale of the collection for the fixed price.

An item sale module 206 sets the listing settings for the respective items in the collection based on input received from the seller. The item sale module may allow the seller to set a fixed price and/or a reserve price according to a selected offering type for each individual item. The offering type of the individual items may be the same for each item or may be determined independently for each item. Further the offering type of the items is determined independently, and may be different, from the offering type of the collection as determined by the collection sale module 204.

In instances where a second seller adds items to the collection, the offering type for the item added by the second seller is determined based on input received from the first seller and based on input received by the second seller. For example, the first seller may provide a minimum price (reserve price or fixed price) that the second seller may set for the added item. The second seller may independently set a reserve price or a fixed price for the added item for sale.

A termination module 208 determines one or more conditions to terminate the sale of the collection once it has been initiated by the seller. The durations of the sales of the collection as a whole and the respective items is referred to as the offering period. The offering period may be set according to one or more conditions (e.g., until a fixed price bid is received or until a reserve price is met) or may be a predefined period (e.g., one week). The sale may be terminated according to an early termination condition or an ultimate termination condition. Once a termination condition is satisfied, the sale of the collection ends and a buyer is determined.

An early termination condition is a termination condition that may end the sale before a planned end of the sale based on buyer activity. One example of an early termination condition is that a fixed price for the collection as a whole has been offered by a buyer. An early termination condition may operate to end either the sale of the collection as a whole or the sale of the respective items in the collection. Another early termination condition may specify that once a reserve price for the collection as a whole has been met, the respective sales of the respective items in the collection may be terminated while the auction for the collection as a whole continues.

An ultimate termination condition is a termination condition that ends the sale independent of buyer activity. An example of an ultimate termination condition is a planned end time of an auction or a fixed price sale.

When the sale has ended, a comparison module 210 is configured to, based on buyer activity, determine whether the collection is sold as a whole or as individual items. The comparison is made automatically, without human intervention. The comparison module 210 may operate according to one or more sets of conditions set by the seller. In one embodiment, the comparison module 210 compares a sum of auction bids or fixed price bids for the respective items to a maximum bid or fixed price bids for the collection as a whole. The higher of the sum for the respective items and the bid for the collection as a whole is determined to be winning.

In some instances, to bias the sale towards selling the collection as a whole rather than as individual items, the seller may provide a bias price. The bias price is an amount of money the seller is willing to lose by selling the collection as a whole rather than as individual items. The comparison module 210 may, when comparing the sum for the respective items to the bid or offer for the collection as a whole, add the bias price to the bid or offer for the collection as a whole. Thus, even if the sum for the respective items exceeds the bid or offer for the collection as whole, the bid or offer for the collection as a whole may still be winning.

In some instances, the bias price, or a portion of the bias price, may be determined dynamically based on one or more transactions costs imposed on the seller by selling to more than one buyer instead of selling to just one buyer. An example of the transaction costs include, for example, fees charged by the online marketplace to publish the listing or to accept payment from the buyer, or shipping and handling costs. The transaction costs may be determined after the ultimate termination condition has been satisfied.

A transaction module 212 facilitates the transaction(s) resulting from the sale of the collection. The transaction module may notify the wining buyer(s), facilitate payment(s), facilitate shipping of the items, and the like.

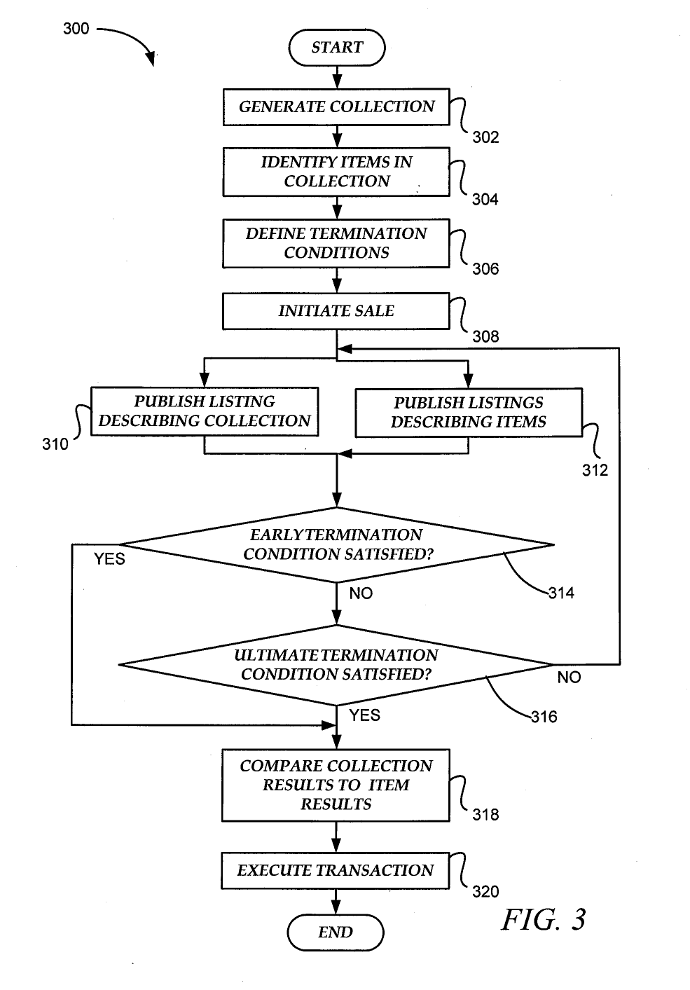

FIG. 3 is a flow chart illustrating a method 300 to offer a collection for sale, according to an example embodiment. The method 300 may be performed by any of the modules, logic, or components described herein. For example, the method 300 may be executed by the collection system 200. The method 300 may be performed by other systems, as well.

In an operation 302, a collection is generated by a seller at the online marketplace by, for example, the collection input module 202 and the collection sale module 204. The collection may be given a title by the seller and associated with a collection identifier by the online marketplace. The seller may provide listing settings for the collection as a whole. The listing settings may include a offering type for the collection as a whole, a reserve price, a fixed price, and a bias price. The seller may further indicate whether certain additional sellers are permitted to add additional items to the collection.

In an operation 304, the items in the collection are identified by the seller using, for example, the collection input module 202 and the item sale module 206. The items may be identified based on images of the items, textual description provided by the seller, product codes or bar codes attached to the item, or the like. In embodiments where the seller allows additional sellers to add items to the collection, the additional seller identifies the additional items using the same techniques. The seller (and any additional sellers) may further identify a offering type, fixed price, or a reserve price for the individual items. In some instances, the seller may restrict the listing settings that can be set by the additional sellers. For example, a seller may restrict the additional sellers to an auction offering type and restrict a reserve price that the additional seller can set.

In an operation 306, the termination conditions are defined based on input received from the seller using the termination module 208. The termination conditions may include early termination conditions and ultimate termination conditions. An early termination condition is satisfied by a buyer action and may operate to terminate the sale of the collection as a whole or the sale of the individual items.

In an operation 308, the sale is initiated and the listing describing the collection and the items in the collection is published by the online marketplace. As illustrated by operations 310 and 312, the sale of the collection comprises publishing a listing describing the collection as a whole and publishing separate listings describing the respective items in the collection in an online marketplace. In some instances, the listing of the collection as a whole is published on the same webpage as the listings describing the respective items. In some instances, the respective listings describing the respective items may be published on separate web pages or on a webpage separate from the listing describing the collection as a whole. During the offering period of a sale, buyers are permitted to bid on, or make offers for, the items or the collection as a whole.

In an operation 314, a determination is made by the termination module 208 as to whether an early termination condition has been satisfied by one or more buyer actions. The early termination condition may include, for example, that if a reserve price is met in an auction for the collection as a whole, then the listings describing the respective items are closed or removed from publication. Another early termination condition may be that if a buyer offers a fixed price for the collection or for a particular item in the collection, the sale of the collection or the remaining items in the collection terminates.

In an operation 316, if the early termination conditions are not satisfied, a second determination as to whether an ultimate termination condition is satisfied is made by the termination module 208. In instances where an early termination condition ends a portion of the sale (e.g., ending the sale of the individual items but continuing the sale of the collection as a whole), the method 300 may continue to operation 316. The ultimate termination condition may be a planned end of the sale of the collection (e.g., an end of auction or listing expiration).

In an operation 318, if an early termination condition that ends the sale of both the collection as a whole and the individual items is satisfied or if an ultimate termination condition is satisfied, the resulting high bids or fixed price bids are compared automatically, without human intervention. More specifically, a resulting high bid for the collection as a whole is compared to a sum of the resulting high bids for the respective items in the collection. The highest bids made as of the end of the sale may be simply referred to as bids. The comparison of operation 318 may further take into account a bias price set by the seller. The result of the comparison operation 318 is a determination that the items in the collection have been sold as a whole or if certain individual items in the collection have been sold on a per-item basis.

In an operation 320, the transaction(s) determined by the comparison operation 318 are executed. The transaction may include informing buyer(s) that their bids or offers were successful, managing payments and shipping the items.

In instances where other sellers have added items to the collection, a determination is made as to whether those items have been sold either as part of the collection as a whole or as individual items. A calculation is made to determine an amount the additional seller will be paid for the additional items. In instances where the additional items are sold individually, the second seller may receive all or part of the price for the additional items. In instances where the individual items are sold as part of the collection as a whole, the second seller may receive a portion of the price of the collection as a whole.

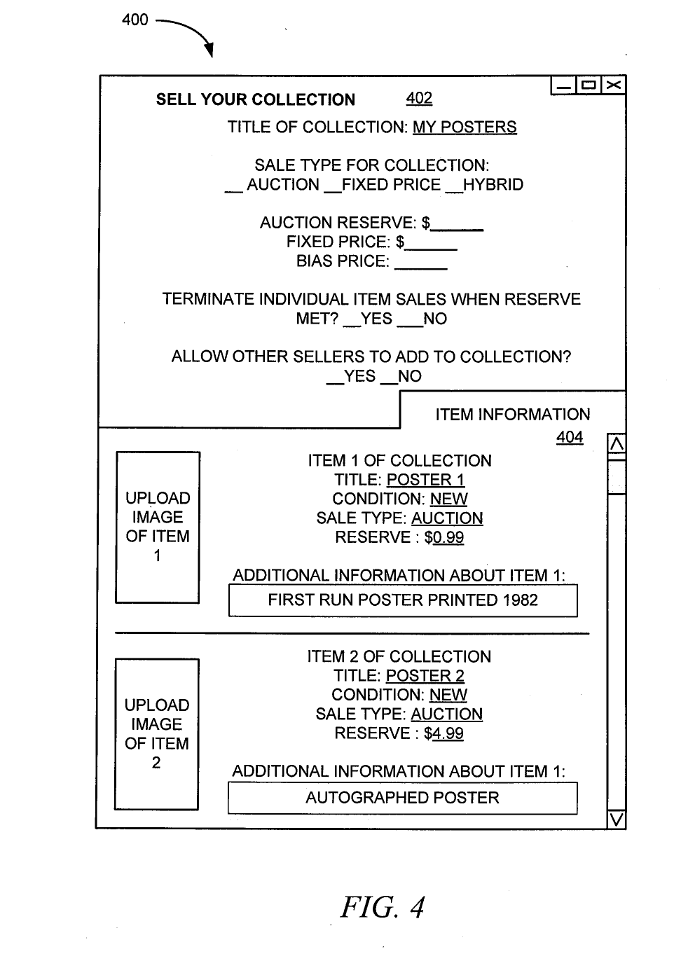

FIG. 4 is a portion of an example user interface 400 that may be displayed to a seller in an example embodiment. The user interface 400 includes a first portion 402 for receiving listing settings from the seller for the collection as a whole. For example, the first portion 402 includes a text field for receiving a title of the collection, a series of options for selecting an offering type for the collection as a whole, and a series of fields for receiving an auction reserve, a fixed price, and a bias price. The first portion 402 may further provide one or more options for biasing the sale towards the sale of the collection as a whole such as an option to terminate sales of individual items in the collection when a reserve price for the collection as a whole has been met.

The first portion 402 may further include an option to allow other sellers (e.g., group members) to add additional items to the collection. Upon selection of “YES”, a second interface may be provided where the seller is able to identify the second seller or to identify a group of second sellers who have permission to add items to the collection.

A second portion 404 of the user interface 400 allows a user to provide information about the individual items in the collection. Each individual item may be associated with an image of the item, a title, a condition of the item, an offering type, and a price (e.g., a reserve price or a fixed price). Additional fields may allow the seller to provide additional information.

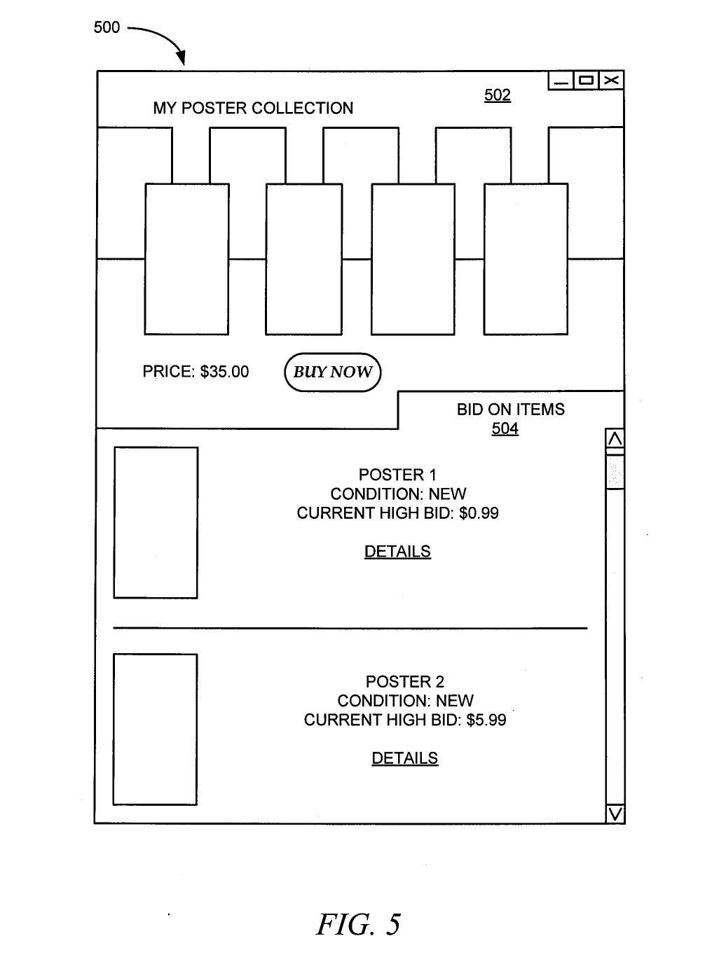

FIG. 5 is a portion of another example user interface 500 that may be displayed to potential buyers in an example embodiment. A first portion 502 of the user interface 500 displays an aggregate of the images of the items in the collection and provides a potential buyer an option to buy the collection as a whole for a fixed price. If the offering type of the collection as a whole is an auction, a reserve price, a current high bid, and an option to bid may be displayed. In some instances, the bias price may be displayed to potential buyers. The first portion 502 may further display one or more early termination conditions.

In a second portion 504 of the user interface 500, the items in the collection are respectively displayed along with an option to purchase the items individually. In some embodiments, the second portion 504 may include a display of a current sum of the current bids for potential buyers.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

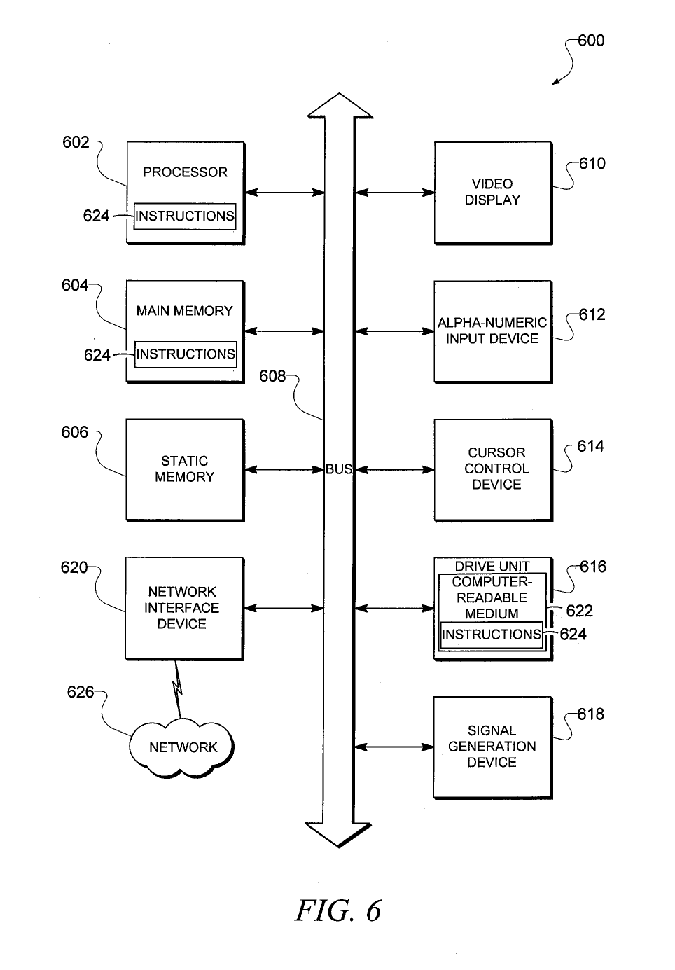

FIG. 6 is a block diagram of machine in the example form of a computer system 600 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a collection input module to receive a description of a collection and description of items in the collection from a device of a seller;
a collection sale module to offer the collection for sale by publishing a description of a sale of the collection as a whole according to a first offering type;
an item sale module to offer the items in the collection for sale by publishing descriptions of the respective items in the collection concurrently with the offer for sale of the collection as a whole according to a second offering type; and
a comparison module to, upon conclusion of an offering period for the collection as a whole and the respective items, compare, using one or more processors, a sum of bids for the respective items received by the item sale module to a bid for the collection as a whole received by the collection sale module and to determine whether the collection is sold as a whole based on the comparison.

2. The system of claim 1, wherein the first offering type and the second offering type are the same offering type.

3. The system of claim 1, wherein the first offering type and the second offering type are distinct offering types.

4. The system of claim 1, wherein the first offering type or the second offering type is selected from the group consisting of an auction, a fixed price sale, and a hybrid sale.

5. The system of claim 1, wherein the collection sale module is further to receive a reserve price and a bias price for the collection as a whole.

6. The system of claim 5, wherein the comparison module is further to add the bias price to the offer for the collection as a whole before the comparison.

7. The system of claim 5, wherein an indication of the bias price is received from the seller.

8. The system of claim 5, wherein the bias price is determined based on shipping costs of the respective items.

9. The system of claim 1, further comprising a termination module to determine that an early termination condition is satisfied based on an action by a buyer.

10. The system of claim 9, wherein the early termination condition, when satisfied, operates to conclude the offering period for the respective items in the collection while continuing the sale of the collection as a whole.

11. The system of claim 9, wherein the early termination condition, when satisfied, operates to conclude the offering period for the respective items in the collection and the sale of the collection as a whole.

12. The system of claim 9, wherein the early termination condition is that a reserve price is met in the sale of the collection as a whole.

13. The system of claim 9, wherein the early termination condition is that a fixed price is offered in the sale of the collection as a whole.

14. The system of claim 9, wherein the termination module is further to determine that an ultimate termination condition is satisfied and to conclude the offering period for the respective items in the collection and the sale of the collection as a whole independent of the action by the buyer.

15. The system of claim 1, wherein the collection input module is further to receive an indication that one or more additional sellers are allowed to add additional items to the collection.

16. The system of claim 15, wherein the collection input module is further to receive a description of the additional items from the additional sellers.

17. The system of claim 15, wherein the additional items added to the collection are subject to restrictions on offering type and price set by the seller.

18. The system of claim 1, further comprising a transaction module to facilitate a transaction between the seller and a buyer of the collection as a whole or a buyer of a particular item in the collection.

19. A method comprising:
receiving a description of a collection and description of items in the collection from a device of a seller;
offering the collection for sale by publishing a description of a sale of the collection as a whole according to a first offering type of the collection as a whole;
offering the items in the collection for sale by publishing descriptions of the respective items in the collection concurrently with the offer for sale of the collection as a whole according to a second offering type of the respective items;
upon conclusion of an offering period for the collection as a whole and the respective items, comparing, using one or more processors, a sum of bids for the respective items to a bid for the collection as a whole; and
determining whether the collection is sold as a whole based on the comparison.

20. A non-transitory machine-readable medium having instructions embodied thereon that when executed cause a machine to perform operations comprising:
receiving a description of a collection and description of items in the collection from a device of a seller;
offering the collection for sale by publishing a description of a sale of the collection as a whole according to a first offering type of the collection as a whole;
offering the items in the collection for sale by publishing descriptions of the respective items in the collection concurrently with the offer for sale of the collection as a whole according to a second offering type of the respective items;
upon conclusion of an offering period for the collection as a whole and the respective items, comparing, using one or more processors, a sum of bids for the respective items to a bid for the collection as a whole; and
determining whether the collection is sold as a whole based on the comparison.
